(19) United States
(12) Patent Application Publication
(10) Pub. No.: US 2023/0368253 A1
(43) Pub. Date: Nov. 16, 2023

(54) Methods for Locaton Based Targeted Recommendation

(71) Applicant: Beacon Mobile, LLC (D/B/A) Brightr Travel, Bala Cynwyd, PA (US)

(72) Inventors: Matthew Mason, Gladwyne, PA (US); Alex Ivanisov, Kyiv (UA); Cyril Boichenko, Zaporizhzhia (UA); Ihor Zhylenko, Zaporizhzhia (UA); Igor Diakov, Kyiv (UA)

(21) Appl. No.: 18/026,055

(22) PCT Filed: Sep. 14, 2021
(86) PCT No.: PCT/US2021/050286

§ 371 Date: Mar. 13, 2023

Related U.S. Application Data
(60) Provisional application No. 63/078,219, filed on Sep. 14, 2020.

(51) Int. Cl. G06Q 30/0282

(52) U.S. Cl. CPC G06Q 30/0282

(57) ABSTRACT

A computer-implemented method for location-based targeted recommendations comprising identifying a location of a user using a user device. Local business data within a vicinity of the identified location of the user, wherein the local business data comprises a list of local businesses with principal place of business or headquarters within the vicinity of the identified location is determined. The determined local business data is filtered based on user criteria, and the filtered local business data is provided to the user device.

This application claims the benefit of U.S. Provisional Patent Application Ser. No. 63/078,219, filed Sep. 14, 2020, which is hereby incorporated by reference in its entirety.

### TECHNICAL FIELD

The present application generally relates to providing content to a consumer, and more particularly, to provide location based targeted recommendations and devices thereof.

### BACKGROUND

Prior technologies provide personalized content to the user based on the user device. Alternatively, the personalized content to the user may also be provided based on historical data that is identified based on point of interest or location. However, the technological problem in the prior technologies is that the inconsistency in the data associated with point of interest of the user may cause the personalized content to be inaccurate. Additionally, prior technologies only provide location-based recommendations or suggestions by providing a list of all activities, restaurants or services within a vicinity of the user. However, another technological problem associated with these recommendations or suggestions is that they are not restricted to the local businesses that either have their principal place of business, headquarters, or started the business within the vicinity. Therefore, there is a need for a technological solution where a system can provide more accurate and location-based recommendations to the user.

### SUMMARY

This technology provides a number of advantages including providing a method, non-transitory computer readable medium, and apparatus, that assist with providing location-based targeted recommendations. By using the techniques disclosed herein, the disclosed technology provides a technological solution by only providing the list of local businesses that either have their principal place of business, headquarters, or started the business within the vicinity. Additionally, the disclosed technology also improves the existing technology by providing a subset of the description associated with the local business based on the criteria provided by the user, as opposed to providing the entire description of the local business as additional information to the user. By providing only a subset of the description of the local business, the disclosed technology is able to advantageously provide only relevant information to the user.

Embodiments provide a computer-implemented method for location-based targeted recommendation, and includes identifying a location of a user using a user device. Local business data within a vicinity of the identified location of the user, wherein the local business data comprises a list of local business with principal place of business or headquarters within the vicinity of the identified location, is determined. The determined local business data of the user device is provided.

In one embodiment, user data comprising one or more insights relating to usage of the determined local business data to a merchant device is provided.

In another embodiment, additional business data associated with a business based on a selection of the businesses received from the user is provided.

In yet another embodiment, the user device associated with the user prior to identifying the location is registered using a registration code.

In another embodiment, the local business data is determined based on preference data received from the user of the user device.

In another illustrative embodiment, a non-transitory computer readable medium comprising a computer usable or readable medium having a computer readable program is provided. The computer readable program, when executed on a processor, causes the processor to perform various ones of, and combinations of, the operations outlined above with regard to the method illustrative embodiment.

In yet another illustrative embodiment, a system is provided. The system may comprise a full question generation processor configured to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is an example of a block diagram of a network environment 10 including a recommendation computing system 14 for providing location-based targeted recommendation;

FIG. 2 is an example of a block diagram of a recommendation computing system 14;

FIG. 3 is an exemplary flowchart illustrating a method 300 for providing location-based targeted recommendations; and

FIGS. 4-7 are exemplary images illustrating location based targeted recommendations.

### DETAILED DESCRIPTION OF EXEMPLARY EMBODIMENTS

The present invention may be a system, a method, and/or a computer program product for refining dataset to provide location-based targeted recommendation. The computer program product may include a computer-readable storage medium (or media) having computer-readable program instructions thereon for causing a processor to carry out aspects of the present invention.

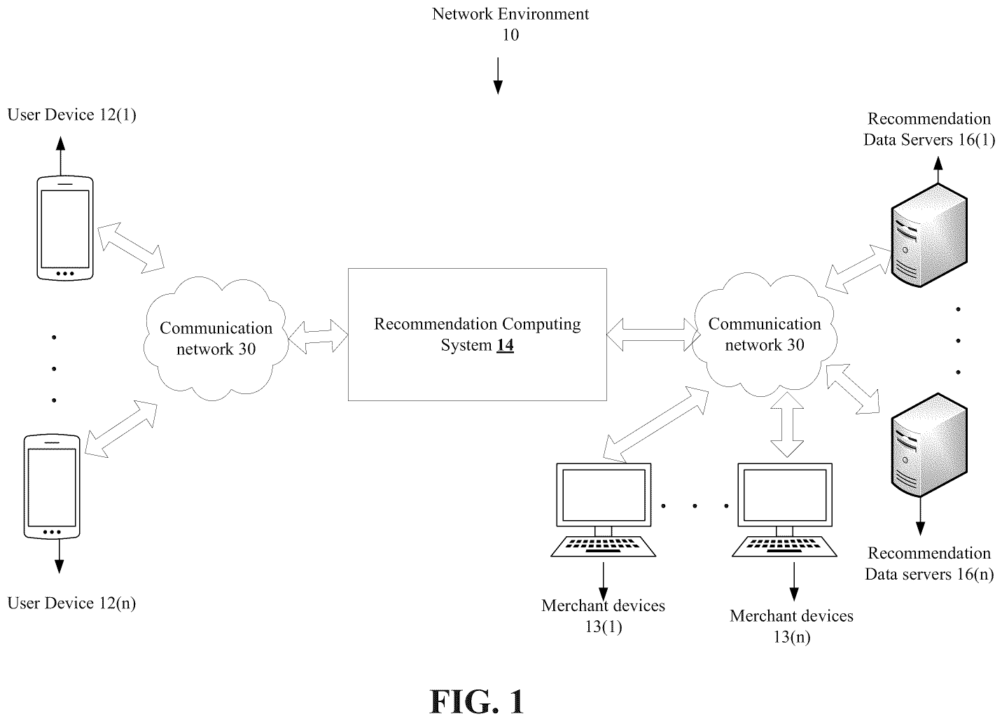

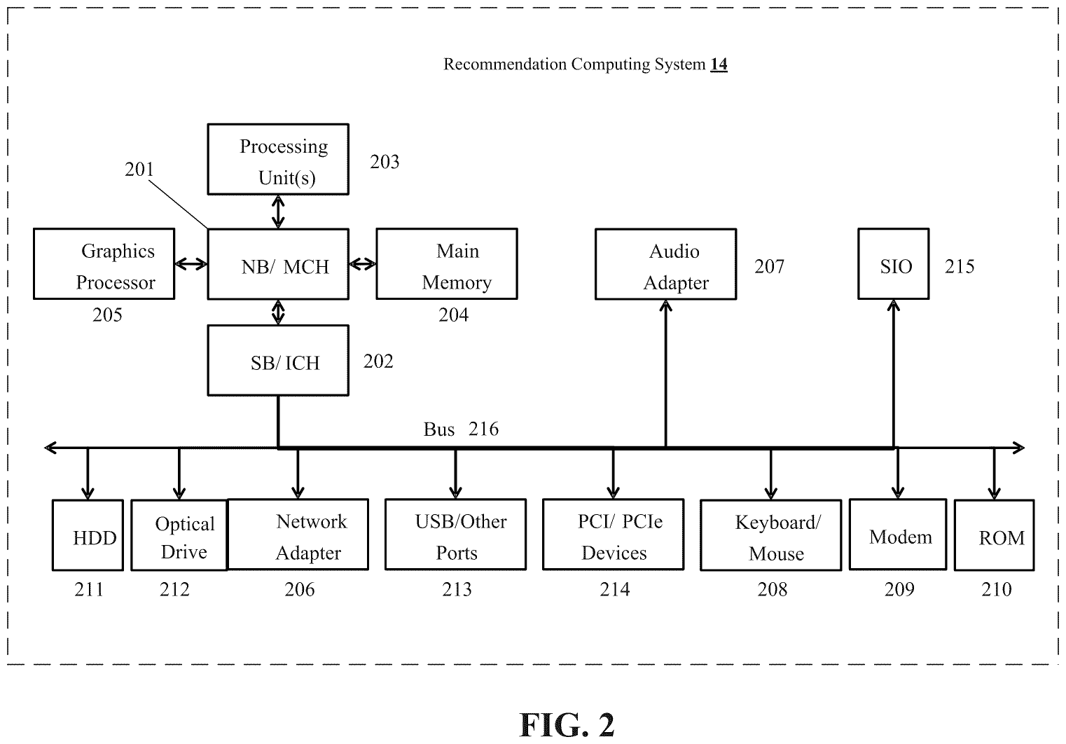

A network environment 10 with an example of a recommendation computing system 14 is illustrated in FIGS. 1-2. In this particular example, the environment 10 includes one or more user devices 12(1)-12(n), one or more merchant devices 13(1)-13(n), the recommendation computing system 14 and one or more recommendation data servers 16(1)-16(n), coupled via one or more communication networks 30, although the environment could include other types and numbers of systems, devices, components, and/or other elements as is generally known in the art and will not be illustrated or described herein. This technology provides a number of advantages including providing methods, a non-transitory computer readable medium, and systems that provide location-based targeted recommendations.

Referring more specifically to FIGS. 1-2, the recommendation computing system 14 is programmed to provide location-based targeted recommendations. Now referring to FIG. 2, the recommendation computing system 14 can employ a hub architecture including a north bridge and memory controller hub (NB/MCH) 201, and south bridge and input/output (I/O) controller hub (SB/ICH) 202. Processing unit 203, main memory 204, and graphics processor 205 can be connected to the NB/MCH 201. Graphics processor 205 can be connected to the NB/MCH 201 through an accelerated graphics port (AGP).

In the depicted example, the network adapter 206 connects to the SB/ICH 202. The audio adapter 207, keyboard and mouse adapter 208, modem 209, read-only memory (ROM) 210, hard disk drive (HDD) 211, optical drive (CD or DVD) 212, universal serial bus (USB) ports and other communication ports 213, and the PCI/PCIe devices 214 can connect to the SB/ICH 202 through bus system 216. PCI/PCIe devices 214 may include Ethernet adapters, add-in cards, and PC cards for notebook computers. ROM 210 may be, for example, a flash basic input/output system (BIOS). The HDD 211 and optical drive 212 can use an integrated drive electronics (IDE) or serial advanced technology attachment (SATA) interface. The super I/O (SIO) device 215 can be connected to the SB/ICH.

An operating system can run on processing unit 203. The operating system can coordinate and provide control of various components within the recommendation computing system 14. As a client, the operating system can be a commercially available operating system. An object-oriented programming system, such as the Java™ programming system, may run in conjunction with the operating system and provide calls to the operating system from the object-oriented programs or applications executing on the recommendation computing system 14. As a server, the recommendation computing system 14 can be an IBM® eServer™ System p® running the Advanced Interactive Executive operating system or the Linux operating system. The recommendation computing system 14 can be a symmetric multiprocessor (SMP) system that can include a plurality of processors in the processing unit 203. Alternatively, a single processor system may be employed.

Instructions for the operating system, the object-oriented programming system, and applications or programs are located on storage devices, such as the HDD 211, and are loaded into the main memory 204 for execution by the processing unit 203. The processes for embodiments of the full question generation system can be performed by the processing unit 203 using computer usable program code, which can be located in a memory such as, for example, main memory 204, ROM 210, or in one or more peripheral devices.

A bus system 216 can be comprised of one or more busses. The bus system 216 can be implemented using any type of communication fabric or architecture that can provide for a transfer of data between different components or devices attached to the fabric or architecture. A communication unit such as the modem 209 or network adapter 206 can include one or more devices that can be used to transmit and receive data.

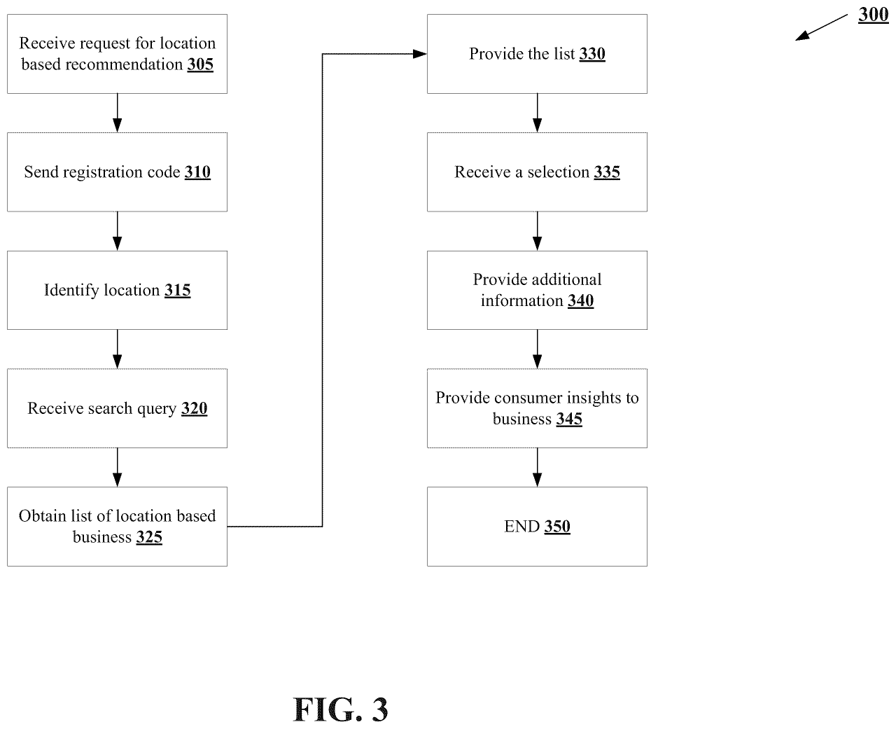

Those of ordinary skill in the art will appreciate that the hardware depicted in FIG. 2 may vary depending on the implementation. For example, the recommendation computing system 14 includes several components that would not be directly included in some embodiments illustrated in FIGS. 3-7. However, it should be understood that the embodiments illustrated in FIGS. 3-7 may include one or more of the components and configurations of the recommendation computing system 14 for performing processing methods and steps in accordance with the disclosed embodiments.

Moreover, other internal hardware or peripheral devices, such as flash memory, equivalent non-volatile memory, or optical disk drives may be used in addition to or in place of the hardware depicted. Moreover, the recommendation computing system 14 can take the form of any of a number of different data processing systems, including, but not limited to, client computing devices, server computing devices, tablet computers, laptop computers, telephone or other communication devices, personal digital assistants, and the like. Essentially, the recommendation computing system 14 can be any known or later developed data processing system without architectural limitation.

Referring back to FIG. 1, each of the one or more user devices 12(1)-12(n) may request location-based recommendations to the recommendation computing system 14 via one or more of the communication networks 30, for example, although other types and/or numbers of storage media in other configurations could be used. In this particular example, each of the one or more user devices 12(1)-12(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the plurality of data servers one or more user devices 12(1)-12(n), and may transmit data in response to requests from the recommendation computing system 14. Each of the one or more user devices 12(1)-12(n) may include a processor, a memory, and a communication interface, which are coupled together by a bus or other link, although each may have other types and/or numbers of other systems, devices, components, and/or other elements.

Each of the one or more merchant devices 13(1)-13(n) illustrated in FIG. 1 may receive user data via the recommendation computing system 14 via one or more of the communication networks 30, for example, although other types and/or numbers of storage media in other configurations could be used. In this particular example, each of the one or more merchant devices 13(1)-13(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the one or more merchant devices 13(1)-13(n) and may transmit data in response to requests from the recommendation computing system 14. Each the one or more merchant devices 13(1)-13(n) may include a processor, a memory, and a communication interface, which are coupled together by a bus or other link, although each may have other types and/or numbers of other systems, devices, components, and/or other elements.

Next, each of the one or more recommendation data servers 16(1)-16(n) may store and provide data to the recommendation computing system 14 via one or more of the communication networks 30, for example, although other types and/or numbers of storage media in other configurations could be used. In this particular example, each of the one or more recommendation data servers 16(1)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the one or more recommendation data servers 16(1)-16(n) and may transmit data in response to requests from the recommendation computing system 14. Each the one or more recommendation data servers 16(1)-16(n) may include a processor, a memory, and a communication interface, which are coupled together by a bus or other link, although each may have other types and/or numbers of other systems, devices, components, and/or other elements.

The non-transitory computer-readable storage medium can be a tangible device that can retain and store instructions for use by an instruction execution device. The non-transitory computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A non-transitory computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The non-transitory computer-readable program instructions described herein can be downloaded to respective computing/processing devices from a computer-readable storage medium or to an external computer or external storage device via a communication network 30, for example, the Internet, a local area network (LAN), a wide area network (WAN) and/or a wireless network. The communication network 30 may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of communication network 30, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operations steps to be performed on the computer, other programmable apparatus, or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present description and claims may make use of the terms “a,” “at least one of,” and “one or more of,” with regard to particular features and elements of the illustrative embodiments. It should be appreciated that these terms and phrases are intended to state that there is at least one of the particular features or elements present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The system and processes of the Figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112 (f), unless the element is expressly recited using the phrase “means for.”

An exemplary method for providing location based targeted recommendation will now be illustrated with reference to FIGS. 3-7. The exemplary method 300 begins at step 305 where the recommendation computing system 14 receives a request to access location-based targeted recommendations in the form of a uniform resource location (URL) from one of the user devices 12(1)-12(n), although the recommendation computing system 14 can receive other types or amounts of requests from other devices.

Next, in step 310, the recommendation computing system 14 sends a registration code back to the requesting user device 12(1)-12(n), which the user device can register to access location based targeted recommendation. Additionally, the requesting user device 12(1)-12(n) can send user data such as name, age, or gender, of the user associated with the requesting user device 12(1)-12(n) during the registration process.

In step 315, the recommendation computing system 14 identifies the location of the requesting user device 12(1)-12(n) using the global positioning system (GPS) data on the requesting user device 12(1)-12(n), although the recommendation computing system 14 can identify the location based on the user inputting the location via the user interface on the requesting user device 12(1)-12(n).

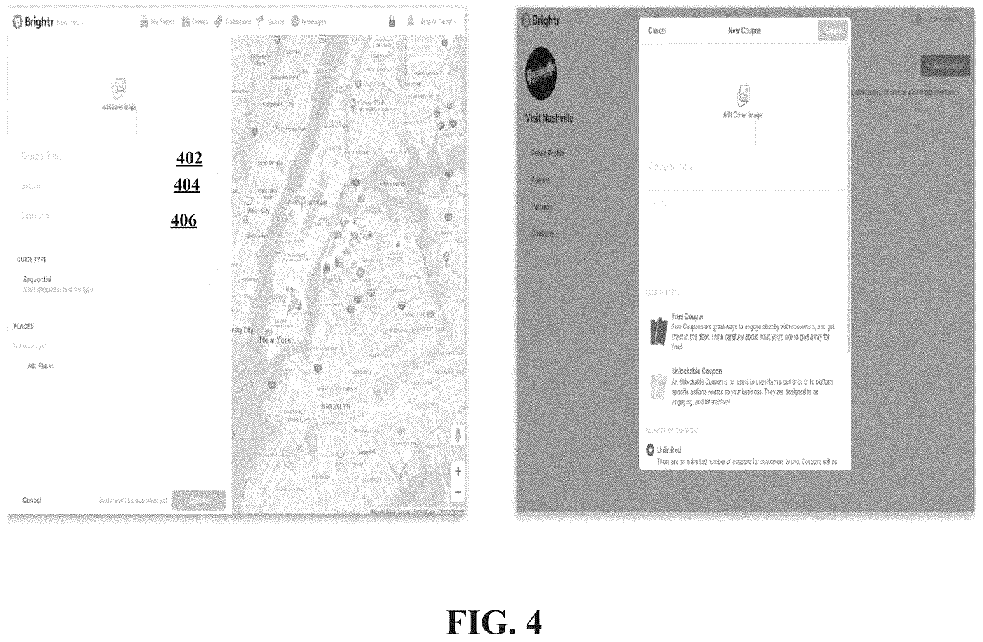

In step 320, the recommendation computing system 14 receives a search query via a text fields 402-408 in fillable form regarding the preference of the targeted recommendation that the user of the user device 12(1)-12(n) would like to receive. An example of such a form is illustrated in FIG. 4. By way of example, the user of the user device can request for curbside pickup, drivethru pickup or online classes through text fields 402-408, although the user can also request other types of services such as restaurants, salons, bakeries and grocery stores, among other types of services.

In step 325, the recommendation computing system 14 obtains a list of local business that match with the preference received in the search query from the one or more data servers 16(1)-16(n). In this example, “local business” relates to business having its principal place of business or headquarters within the vicinity of the identified location of the requesting user device. By way of example, the one or more merchant devices 13(1)-13(n) can register their business as having principal place of business or having headquarters at a geographic location, and this registered information is stored at the one or more recommendation data servers 16(1)-16(n). Further, the stored data in the one or more recommendation data servers 16(1)-16(n) can be obtained by the recommendation computing system 14 via the communication network 30. In this example, the obtained list of local business only includes the business having its principal place of business or headquarters within the vicinity of the identified location, although the list may include other businesses within the vicinity of the identified location of the requesting user device 12(1)-12(n) in other examples.

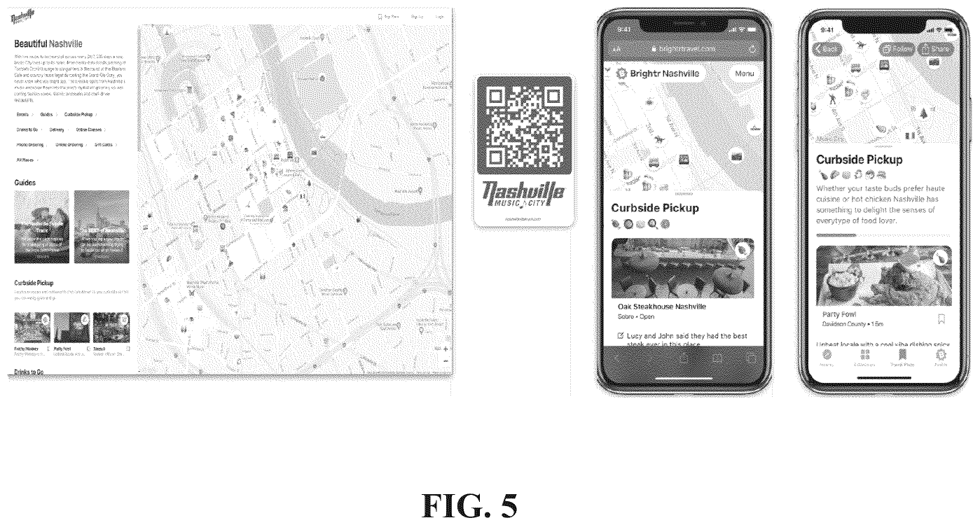

In step 330, the recommendation computing system 14 provides the obtained list of local businesses to the requesting one of the one or more user devices 12(1)-12(n). An example of step 330, where the recommendation computing system 14 provides the obtained list, is illustrated in FIG. 5. As illustrated in FIG. 5, the recommendation computing system 14 can provide the list to the requesting one of the one or more user devices 12(1)-12(n) as locations within a map (as shown in the left part of the FIG. 5) or as a sorted list (as shown in the right part of the FIG. 5). In this example, the list is sorted based on the proximity to the user, although the list can be further sorted and learnt as the system gains more users and interactions, such as user's preference to certain cuisine or the rating of the business.

In step 335, the recommendation computing system 14 receives a selection of one of the businesses provided in the list from the requesting one of the one or more user devices 12(1)-12(n) via the interface of the requesting one of the one or more user devices 12(1)-12(n). In this example, the user can make purchases (deals, coupons, tickets) directly in the app itself, and then redeem them at places of business after making a selection via an interface illustrated in FIG. 4.

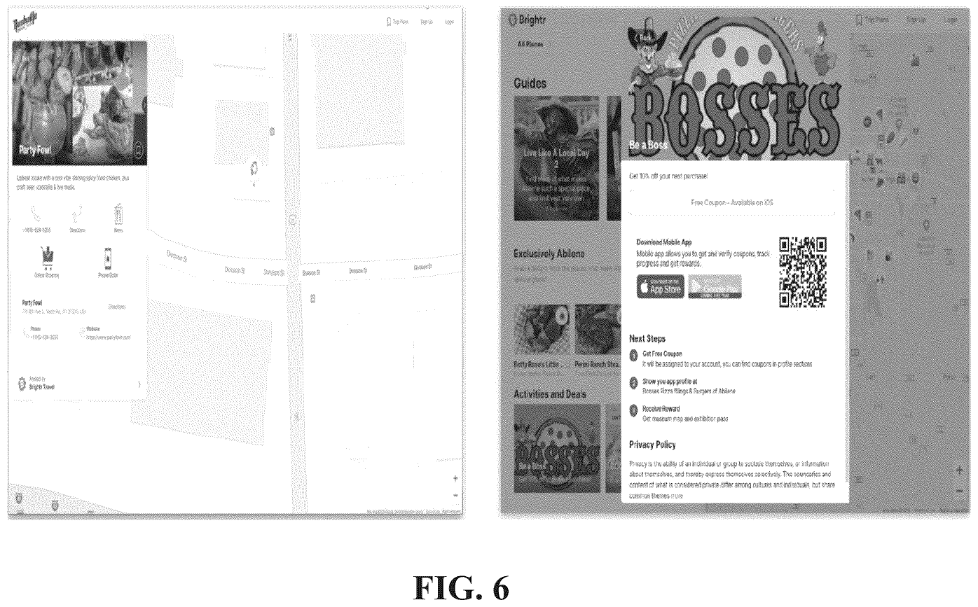

In step 340, the recommendation computing system 14 provides additional description associated with the selected business to the requesting one of the one or more user devices 12(1)-12(n). An example of providing the additional description is illustrated in FIG. 6. In this example, the additional description includes detailed information about the business and directions to the business from the current location of the user using the requesting user device 12(1)-12(n). In this example, the additional information is filtered based on one or more user criteria. By way of example, if the user of the requesting one of the one or more user devices 12(1)-12(n) has a preference for a specific cuisine, and the restaurant within the vicinity is a multi-cuisine restaurant, the recommendation computing system 14 can only provide additional information associated with the cuisine of the user's preference, and not provide the information associated with other cuisine in the restaurant. In addition to description and hours, the disclosed technology can add customized buttons, i.e. menu, reservations, schedule, online class etc. Alternatively, in another example, the additional information that is provided to user can include pandemic-related health protocols that must be followed inside the business.

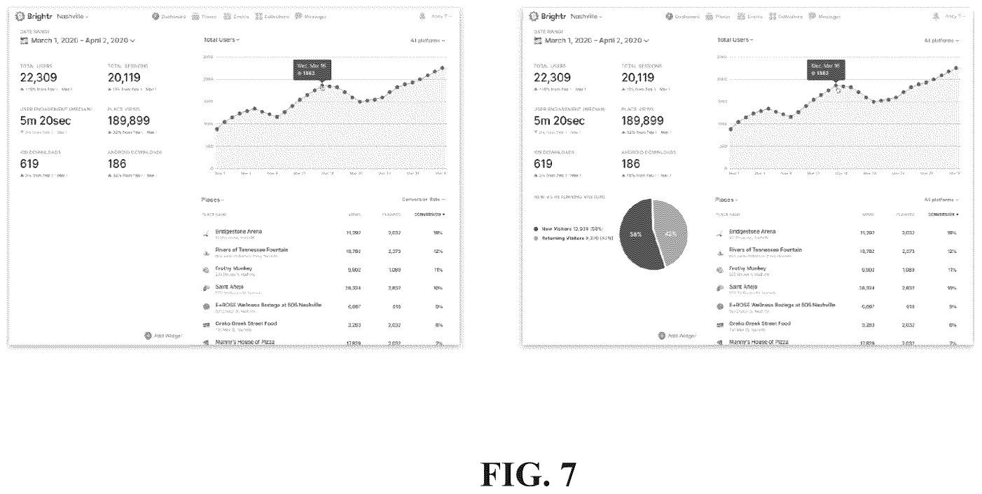

In step 345, the recommendation computing system 14 provides user data associated with the user using the user device to the one or more merchant devices 13(1)-13(n) that is related to the user's selection. In this example, the business can use this user data to get insights regarding the consumer habits. An example of this is illustrated in FIG. 7. In this example, data associated with the user device and the user is collected, and unique users, sessions, time engagement with platform, views of individual places, and conversion rate is shared. As active spending begins, the recommendation computing system 14 determines the parameters that influenced the user to make a purchase at the local business. By way of example, the parameters can include the provided description, an emoji posted by the local business or other users, or a picture that is posted by another user. In this example, the recommendation computing system 14 can determine these parameters by identifying the user interaction of the provided information. For example, if the user of the requesting one of the one or more user devices looks at the menu and then decides to visit a local restaurant, then the recommendation computing system 14 provides insights to the local business to further improve the accessibility to the online menu. In another example, if the user of the requesting one of the one or more user devices 12(1)-12(n) decides to visit the restaurant immediately after viewing an image of a particular dish that is posted by the local restaurant, then the insight can be provided to the local business to increase the quality of the images of the dishes in the menu. This info will then be used to provide recommendations that will assist a business in encouraging more spending. The exemplary method ends at step 350.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A method comprising:
identifying, by a recommendation computing system, a location of a user using a user device;
determining, by the recommendation computing system, local business data within a vicinity of the identified location of the user using the user device, wherein the local business data comprises a list of local businesses with principal place of business or headquarters within the vicinity of the identified location;
filtering, by the recommendation computing system, the determined local business data within the vicinity of the identified location based on one or more user criteria; and
providing, by the recommendation computing system, the filtered business data to the user device.

2. The method as set forth in claim 1 further comprising, providing, by the recommendation computing system, user data comprising one or more insights relating to usage of the determined local business data to a merchant device.

3. The method as set forth in claim 1 further comprising, providing, by the recommendation computing system, additional business data associated with a business based on a selection of the business received from the user.

4. The method as set forth in claim 1 further comprising, registering, by the recommendation computing system, the user device associated with the user prior to identifying the location.

5. The method as set forth in claim 1 wherein the local business data is determined based on preference data received from the user of the user device.

6. The method as set forth in claim 4 wherein a registering code is sent to the user device as part of the registration.

7. A non-transitory machine readable medium having stored thereon instructions comprising machine-executable code which, when executed by at least one machine, causes the machine to:
identify a location of a user using a user device;
determine local business data within a vicinity of the identified location of the user using the user device, wherein the local business data comprises a list of local businesses with principal place of business or headquarters within the vicinity of the identified location;
filter the determined local business data within the vicinity of the identified location based on one or more user criteria; and
provide the filtered business data to the user device.

8. The medium as set forth in claim 7 further comprising, providing user data comprising one or more insights relating to usage of the determined local business data to a merchant device.

9. The medium as set forth in claim 7 further comprising, providing additional business data associated with a business based on a selection of the business received from the user.

10. The medium as set forth in claim 7 further comprising, registering the user device associated with the user prior to identifying the location.

11. The medium as set forth in claim 7 wherein the local business data is determined based on preference data received from the user of the user device.

12. The medium as set forth in claim 10, wherein a registering code is sent to the user device as part of the registration.

13. A recommendation computing system, comprising a memory comprising programmed instructions stored in the memory and one or more processors configured to be capable of executing the programmed instructions stored in the memory to:
identify a location of a user using a user device;
determine local business data within a vicinity of the identified location of the user using the user device, wherein the local business data comprises a list of local businesses with principal place of business or headquarters within the vicinity of the identified location;
filter the determined local business data within the vicinity of the identified location based on one or more user criteria; and
provide the filtered business data to the user device.

14. The system as set forth in claim 13 wherein the one or more processors are further configured to be capable of executing the programmed instructions stored in the memory to provide user data comprising one or more insights relating to usage of the determined local business data to a merchant device.

15. The system as set forth in claim 13 wherein the one or more processors are further configured to be capable of executing the programmed instructions stored in the memory to provide additional business data associated with a business based on a selection of the business received from the user.

16. The system as set forth in claim 13 wherein the one or more processors are further configured to be capable of executing the programmed instructions stored in the memory to register the user device associated with the user prior to identifying the location.

17. The system as set forth in claim 13 wherein the local business data is determined based on preference data received from the user of the user device.

18. The system as set forth in claim in claim 16 wherein a registering code is sent to the user device as part of the registration.
